(19) United States
(12) Patent Application Publication
(10) Pub. No.: US 2005/0045432 A1
(43) Pub. Date: Mar. 3, 2005

(54) Elevator installation with a rocker device as support means fixing point and rocker device for use in an elevator installation

(76) Inventors: Ernst Ach, Ebikon (CH); Roland Grumbrecht, Adligenswil (CH)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/916,790

(22) Filed: Aug. 12, 2004

(30) Foreign Application Priority Data
Aug. 12, 2003 (EP) 03405591.3

(51) Int. Cl. B66B 7/10

(52) U.S. Cl. 187/411; 187/412

(57) ABSTRACT

An elevator installation includes an elevator car, at least one guide rail for vertical guidance of the elevator car, and two support devices, such as ropes or belts, that support a counterweight at one side of the elevator car and underloop the elevator car. Each of the two support devices has one end at a fixing point at one side of the elevator car. A rocker device has two arms and is fastened to the guide rail to provide a rocking movement. Each of the support devices has an opposite end at a fixing point on an associated one of the and the rocking movement provides a length compensation in the case of unequal lengthening of the two support devices.

### BACKGROUND OF THE INVENTION

The present invention relates to an elevator installation with a rocker device used as a support means fixing point.

There are various types of elevator installations that have an even-numbered number of support means, for example flat belts or wedge-rib belts, for supporting and driving the elevator car. The support means are typically fixed in the elevator shaft in the region of a counterweight, support the counterweight, are deflected at an upper (drive) pulley, then run in the form of an underlooping below the elevator car and are fixed in the elevator shaft at the other side of the elevator car. This fixing can be termed a car-side support means fixing point, whereas a fixing in the region of the counterweight is termed a counterweight-side support means fixing point.

There are various possibilities of executing this car-side support means fixing point. Five examples are illustrated in FIGS. 1A to 1E in schematic form and briefly discussed in the following.

In part it is proposed to fix the car-side support means fixing point to a guide rail 5 which serves for vertical guidance of an elevator car. This form of fastening loads the guide rail 5 and leads to a bending moment which acts on the rail 5.

In FIG. 1A there is shown a variant in which the car-side support means fixing point 1 is fastened asymmetrically to the guide rail 5. The support means (not shown in FIGS. 1A to 1E) pull on the support means fixing point 1 with a force F1. A bending moment, which acts on the guide rail 5, thereby results.

In FIG. 1B there is shown a variant in which a car-side support means fixing point 2 is provided, which is supported at one end at the guide rail 5 and at the other end at a point 2.1 against a shaft wall (not shown). An advantage for this variant is that the force introduction into the rail 5 free of a bending moment, whereas a disadvantage is that in the case of subsidence of the elevator shaft or in the case of temperature induced expansions of the rail 5 a skewed setting can arise. Moreover, the wall of the elevator shaft is loaded by the illustrated form of suspension.

In FIG. 1C there is shown a variant in which a car-side support means fixing point 3 is provided, which is supported at a shaft wall (not shown) without being connected with the guide rail 5. This form of suspension leads to a high wall loading.

A support means fixing point 4 can also be supported on one side at the guide rail 5 and on the other side in a wall niche 7 of an elevator shaft 6, as shown in FIG. 1D. The support in the wall niche 7 is in shape-fitting manner. Advantageous in this variant is the force introduction into the rail 5 free of a bending moment, whereas a disadvantage is that in the case of subsidence of the elevator shaft or temperature induced expansions of the rail 5 a skewed setting can come about. Moreover the wall of the elevator shaft 6 is loaded by the illustrated form of suspension.

According to FIG. 1E a support means fixing point 8 can be mounted at both sides in the wall niches 7 of the elevator shaft 6. There is no loading of the guide rail 5, but the entire load has to be borne by the walls of the shaft 6.

### SUMMARY OF THE INVENTION

An object of the present invention is to provide a support means fixing point for elevator cars which has support means arranged in pairs, wherein the disadvantages of previous solutions are to be avoided or reduced.

It is an advantage of the support means fixing point according to the present invention that the force of the support means is introduced centrally into the guide rail. Bending moments are thereby avoided. A further advantage is that no form of supporting or fixing of the support means at a wall of an elevator shaft is needed. The present invention is thus particularly well suited for elevator installations that manage without an elevator shaft in the conventional sense.

An additional advantage of the present invention is to be seen in that through the rocker device a length compensation between the individual support means is undertaken, since the rocker device has an automatic compensating action on the support means.

The rocker device, in accordance with the present invention, does not need any supporting or fixing at one of the walls of an elevator shaft.

The rocker device, in accordance with the present invention, allows a compensation in case the support means have smaller length differences, in case the layout should overall have smaller asymmetries or in case a differential lengthening of the support means should arise in the course of time.

Depending on the respective form of embodiment a reaction—for example an emergency stop—can be triggered by way of the rocker device in the case of unequal loading or in case one of the support means should break.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIGS. 1 A through 1E show different variants of prior art suspensions for a support means;

FIG. 2 is a schematic perspective view of a first elevator installation according to the present invention;

FIG. 3 is a schematic side elevation view of a further elevator installation according to the present invention;

FIG. 4 shows details of the rocker device shown in FIGS. 1 and 2;

FIG. 5 is a cross-sectional illustration of a rocker device according to the present invention;

FIG. 6 is a schematic view of a rocker device with a limiting device according to the present invention; and

FIG. 7 is a schematic view of a rocker device for four support means according to the present invention.

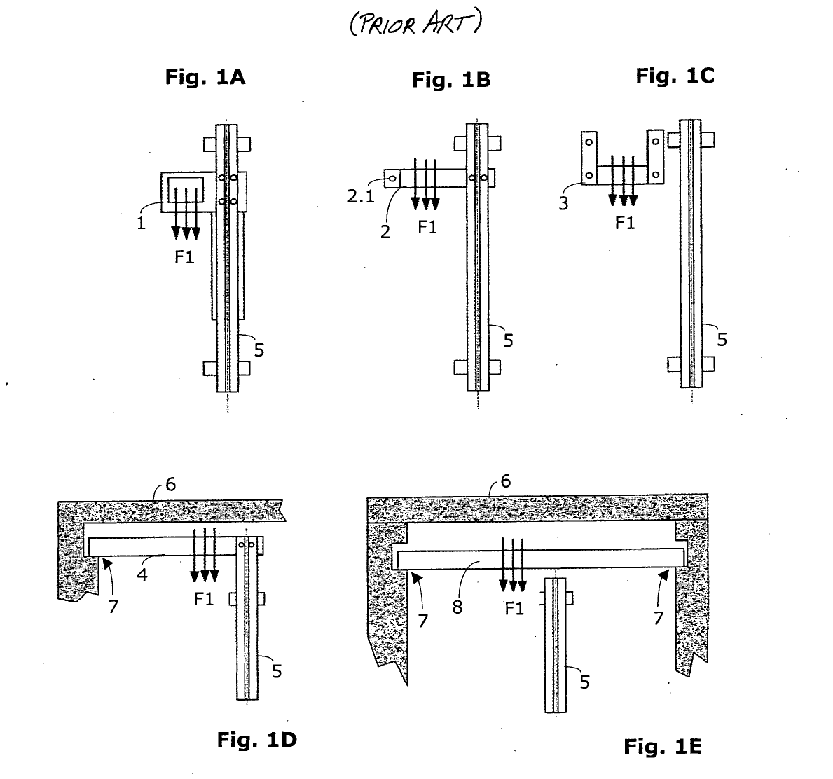

### DESCRIPTION OF THE PREFERRED EMBODIMENT

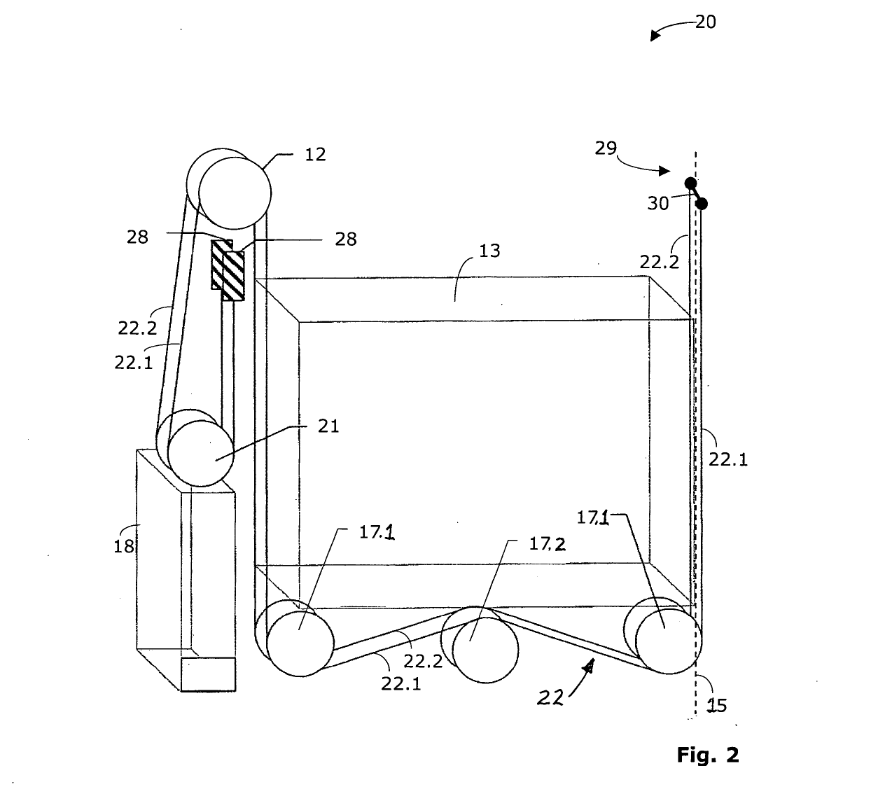

A first embodiment of an elevator installation according to the present invention is shown in FIG. 2 in a schematic perspective view. In this figure there is shown an elevator installation 20 which does not have a machine room and which can comprise an elevator shaft or be executed as “shaftless”.

The present invention relates to the elevator installation 20 that comprises an elevator car 13 and at least one guide rail 15 for vertical guidance of the elevator car 13. The guide rail 15 is illustrated in FIG. 2 only by a dashed line. Two support means 22 extending substantially parallel to one another are provided. In the following description and in the figures a forward or nearer support means is denoted by 22.1 and a rearward farther support means by 22.2, where this is necessary for better distinction. The car-side end of the support means 22 is fixed in the region of a first support means fixing point 29 by way of a rocker device 30 to the guide rail 15. Each of the support means 22.1 and 22.2 underloops the elevator car 13, loops around a drive pulley 12, which is arranged at a drive (not shown), and supports a counterweight 18 in a 2:1 underlooping. In the illustrated example the support means 22 supports the counterweight 18 in such a manner that the support means 22 run around counterweight rollers 21 and are fixed at the counterweight-side end in the region of second support means fixing points 28. The underlooping of the elevator car 13 is effected in the case of the illustrated form of embodiment by car support rollers 17.1 and guide rollers 17.2, which are respectively laid out in pairs.

The rocker device 30 has two arms and is only schematically indicated in FIG. 2. It is so mechanically fastened to the guide rail 15 that a rocking movement of the rocker device 30 is possible about an axis extending substantially perpendicularly to the longitudinal axis of the guide rail 15. A respective one of the support means fixing points 29 is provided at each of the two arms of the rocker device 30. The rocker device 30 allows, in the case of unequal loading of the two support means 22.1 and 22.2, a rocking movement by which a length compensation is automatically undertaken. If a breakage of one of the support means 22.1, 22.2 happens, then the rocker device 30 is abruptly asymmetrically loaded which causes a rocking movement of the rocking device 30 in one direction. This rocking movement can either be detected by means of a sensor or a contactless switch in order to interrupt travel operation of the elevator installation or the rocker device 30 can mechanically engage a speed limiter in order to trigger braking. Alternatively or additionally, a warning signal can be triggered. Further details with respect thereto are described later.

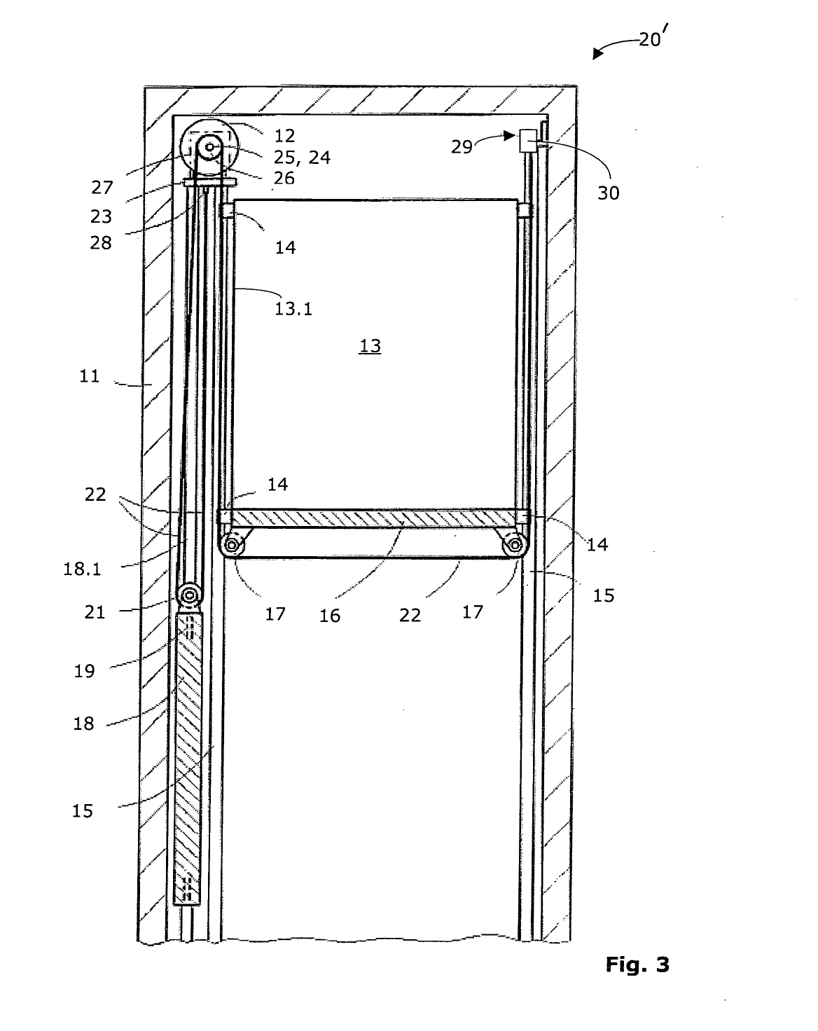

Details of a similar embodiment can be seen in FIG. 3 where like components are identified by the same reference numerals. In FIG. 3 there is shown an elevator installation 20′ without engine room. An elevator shaft 11, in which a drive 10 with a drive pulley or drive pulleys 12 moves the elevator car 13 upwardly and downwardly by way of the support means 22 arranged in a paired manner. The drive 10 inclusive of the drive pulley or pulleys 12 is laterally seated above the elevator car 13 on one of the guide rails 15, which is arranged at the left of the elevator car 13. A further one of the guide rails 15 is disposed on the right of the elevator car 13. Guide shoes 14 are provided at the elevator car 13 in order to vertically guide the elevator car 13 along the two guide rails 15.

Two pairs of the car support rollers 17.1, by way of which the supporting and acceleration forces are transmitted to the elevator car 13, are mounted below a car floor 16 of the elevator car 13. The counterweight 18 is arranged laterally of the elevator car 13. The counterweight 18 is guided along two counterweight guide rails 18.1 by means of counterweight guide shoes 19. The counterweight 18 is supported by the support means 22, which run around the counterweight support rollers 21. The counterweight 18 is thus suspended at the same support means pair 22 as is the elevator car 13.

The drive 10 comprises a drive shaft 24 which acts on a drive pulley shaft 25 and which is oriented parallel to a counterweight-side wall 13.1 of the elevator car 13 and carries at least one drive pulley 26. The drive 10 and the drive pulley shaft 25 together with the at least one drive pulley 12 are fastened on a driver bearer 23, which is supported on the two counterweight guide rails 18.1 and is mechanically connected with this. It is also possible to fasten the drive 10 and the associated elements on or at the guide rail 15 arranged to the left of the elevator car 13. Alternatively, the drive 10 and the associated elements can be supported on the counterweight guide rails 18.1 and the guide rails 15.

A brake unit 27, which enables braking of the elevator car 13, is arranged in the region of the drive 10. The brake unit 27 is indicated in FIG. 3 only by dashed lines, since it is positioned behind the drive 10.

In the case of the embodiment shown in FIG. 3 the counterweight-side support means fixing points 28 of the support means 22 are fastened in the region below the drive bearer 23. This fastening is preferably effected by means of setscrews by way of which the position of the support means end can be individually adjusted. Thus, an adjustment can be undertaken which makes it possible to bring the rocker device 30 into a predefined position, for example a horizontal position.

According to the present invention the two support means 22 (22.1 and 22.2) extend substantially parallel to one another. From the counterweight-side support means fixing points 28 the support means 22 run downwardly, loop partly around the counterweight support rollers 21 and are guided back upwardly in the elevator shaft 11 around the drive pulley or pulleys 26. From there the support means 22 run downwardly along the left or counterweight side wall 13.1 of the elevator car 13 and are then led at least partly around the car support rollers 17.1. This form of suspension is termed “underlooping”. The support means 22 are led upwardly on the right-hand side of the elevator car 13, where each of the support means 22 is fastened in the region of the car-side support means fixing point 29 to an associated arm of the rocker device 30.

The term “support means” is to be understood as a synonym for any form of cables and means suitable for the purpose of supporting and moving the elevator car 13 and the counterweight 18. The support means are preferably flat belts or wedge-rib belts. However, steel or synthetic material cables with round cross-section can also be used as support means in connection with the invention.

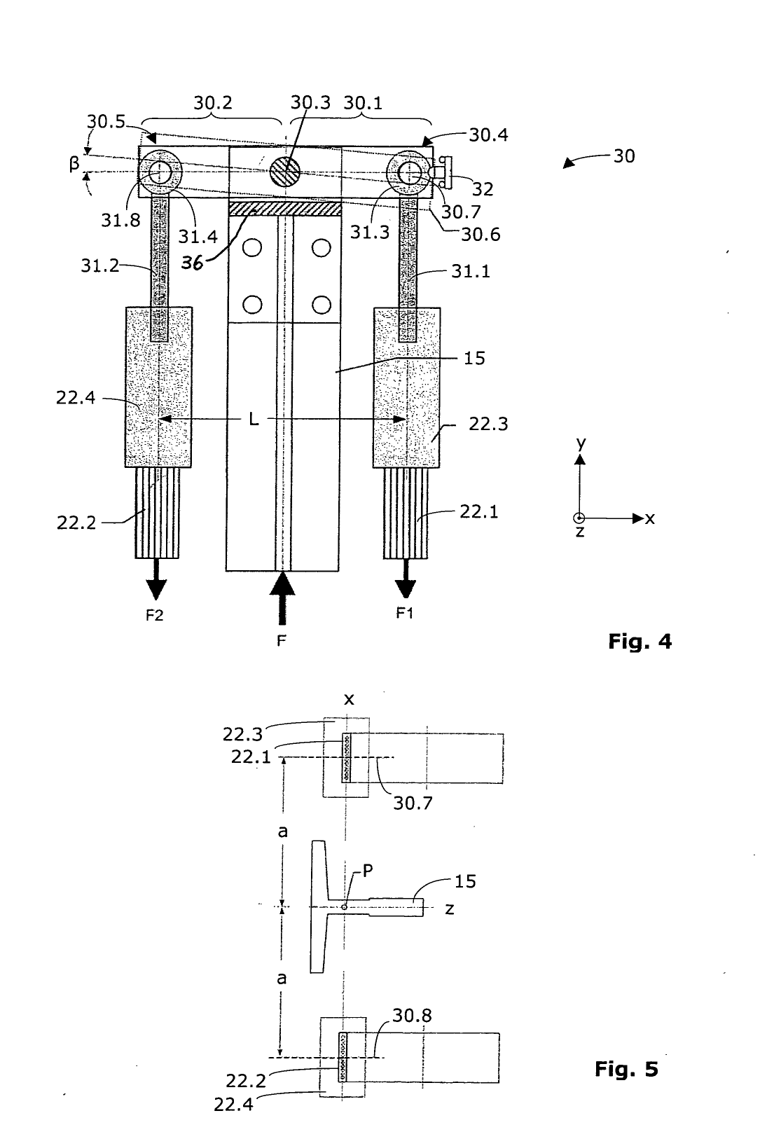

A first embodiment of the rocker device 30 according to the present invention is shown in FIG. 4. The rocker device 30 comprises a first arm 30.1 and a second arm 30.2. These arms 30.1 and 30.2 are preferably not, however, necessarily arranged symmetrically with respect to an axis 30.3 of rotation, which in the illustrated example extends perpendicularly to the plane of the drawing. The axis 30.3 of rotation is located at or on the guide rail 15. Each of the two arms 30.1 and 30.2 has fastening points 30.4 and 30.5 respectively which serve for fastening of the support means 22.1 and 22.2 respectively. It is merely important that the fastening point 30.4 and 30.5 are arranged symmetrically with respect to the axis 30.3 of rotation. In the illustrated example, fastening of the support means 22.1 and 22.2 takes place by means of round rods 31.1, 31.2 respectively, which are constructed in the upper region as eyes 31.3, 31.4 respectively. The eyes 31.3, 31.4 are seated on axles 30.7, 30.8 respectively or the like. Clamping or screw devices 22.3 and 22.4, which receive and fix the ends of the flat belts or wedge-rib belts 22.1, 22.2 respectively, are provided. In the illustrated form of embodiment the support means are wedge-rib belts 22.1, 22.2, as can be recognized on the basis of the parallel extending lines, which are to illustrate the ribs of the belts. The round rods 31.1, 31.2 can be constructed as threaded spindles in order to be able to set the position of the arms of the rocker device 30 by rotation of the round rods 31.1, 31.2.

Due to the fact that the rocker device 30 is arranged at or on the guide rail 15, a part of the load, which is supported by the support means 22.1 and 22.2, is introduced into the guide rail 15. The guide rail 15 therefore has to exert a counter-force F which, however, runs centrally in the guide rail 15 and does not produce any undesired moments of rotation, in the “x-y” plane or in the “y-z” plane, which act on the guide rail 15. Through the rocker device 30 guided free of friction in ideal manner, support means forces are always distributed uniformly to the support means 22.1 and 22.2. A skewed setting of the rocker device 30 can arise in that the support means 22.1 and 22.2 have different lengths or in that asymmetries arise during installation.

In FIG. 4 the rocker device 30 is also shown in a setting which it adopts when the support means 22.1 is shorter than the support means 22.2. This setting of the rocker device 30 is illustrated by dashed lines. Due to the unequal length of the support means 22.1 and 22.2 there results a rocking movement about the axis 30.3, which can be quantified by an angle β. An abutment 36 for the arm of the rocker device 30 can optionally be provided at the guide rail 15.

An optional limiting device 32, which in the case of a rocking movement exceeding a limit value shuts down the elevator installation 20, 20′ and/or brakes the elevator car 13 and/or triggers a warning signal, is shown laterally adjacent to the rocker device 30. This device 32 is, for the sake of simplicity, termed a limiting device herein. It can be, for example, a sensor that electrically connects two contacts as long as the rocker device 30 is disposed in an angular range less than ±β. If the rocker device 30 departs from the angular range ±β upwardly or downwardly, for example as a consequence of differential support means lengthening or in the case of breakage of a support means, then the sensor interrupts the electrically conductive connection. The sensor can be, for example, a component of the safety circuit usually present in elevator installations.

A contactless switch can also be used instead of a sensor for the limiting device 32. In a preferred form of embodiment an inclination sensor or inclination switch is used, which is so arranged in the region of the rocker device 30 that a reaction is triggered when an excessive deflection of the rocker device 30 occurs.

A section which runs through the rocker device 30 and the guide rail 15 is shown in FIG. 5. FIG. 5 serves for explanation of the geometric arrangement of the preferred form of embodiment. The rocker device 30 is preferably so arranged and designed that it is supported on a center P of the area of the guide rail 15 in such a manner that a connecting line X between the two support means runs through this center P. A spacing a of the two axles 30.7 and 30.8, which symbolize the positions of force action of the support means, from the point P is the same for both arms 30.1 and 30.2. The two axles 30.7 and 30.8 are indicated in FIG. 5 by dashed lines.

The connection of the support means 22 with the arms of the rocker device 30 according to the present invention is so constructed that it allows at least small rotational movements. This is necessary, since the support means 22 are each directed vertically downwardly, but the rocker device 30 can execute rocking movements in correspondence with the different support means elongation. As shown in FIG. 4, the rotational movement can be achieved in that the fastening of the support means to the arms 30.1, 30.2 of the rocker device 30 is executed by means of the eyes 31.3, 31.4 and the axles 30.7, 30.8. Instead of the eyes, however, there can also be provided secondary rockers which are connected with the arms 30.1, 30.2 of the rocker device by way of axles. The secondary rockers can execute small rocking movements with respect to the rocker device. Another form of embodiment is distinguished by the fact that the rods 31.1, 31.2 are constructed to be flexible and are fixedly connected, at their upper ends in the region of the eyes, with the arms of the rocker device. The flexibility of the rods 31.1, 31.2 gives the necessary freedom of movement.

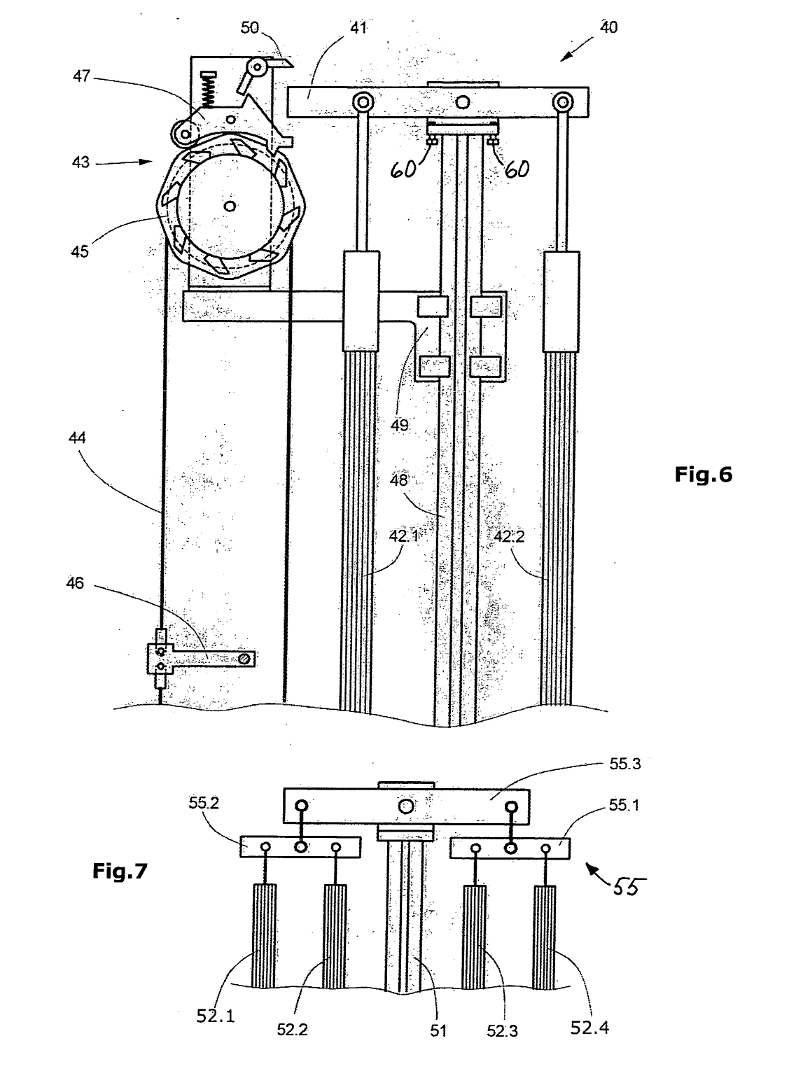

In FIG. 6 there is shown a schematic arrangement which similarly to the limiting device 32 triggers a reaction when the rocking movement exceeds a limit value. If the deflection of the arms of a rocker device 40 exceeds a specific limit due to large length differences of the support means 42.1, 42.2 or in consequence of support means breakage, then a pendulum speed limiter 43 of known construction is forced into a blocking setting by an arm 41.

Such speed limiters 43 are used for limiting the speed of elevator cars. In this connection a closed cable 44, namely a so-termed speed limiter cable, is used as an auxiliary cable. This speed limiter cable 44 runs around a cable roller 45 of the speed limiter 43 which is mounted at the top of the elevator shaft, and around a tensioning roller (not shown in FIG. 6) mounted at the bottom of the elevator shaft. The speed limiter cable 44 is connected by way of a safety brake device trigger lever 46 with the elevator car 13, which is not shown in FIG. 6. If the speed of the elevator car 13 exceeds a certain limit speed, then through a blocking pendulum 47 the cable roller 45 of the speed limiter 43 and therewith the speed limiter cable 44 are blocked in a known manner, whereby the braked speed limiter cable 44 actuates the safety brake device trigger lever 46 moving with the travelling elevator car and thus triggers a safety brake device mounted at the elevator car.

Analogously to the described sequence in the case of too-high speeds, the safety brake device can be triggered if the deflection of the arms of the rocker device 40 exceeds a specific limit due to a large length difference of the support means 42.1, 42.2 or as a consequence of support means breakage. The arm 41 of the rocker device 40 in that case actuates the blocking pendulum 47 directly or by way of a deflecting lever 50 and thereby causes the above-described blocking of the speed limiter 43 and triggering of the safety brake.

As shown in FIG. 6, the rocker device 40 is supported on a guide rail 48. The speed limiter 43 can be carried by way of a mechanical connection 49 from the guide rail 48.

The limiting device 32 (FIG. 4) can also trigger the speed limiter 43 according to FIG. 6 by way of, for example, a stroke magnet.

In the case of a further embodiment the rocker device 30 is so mounted that its rocking movements are lightly damped. Thus, brief fluctuations in load, for example due to oscillations of the elevator car 13, can be damped. Additionally or alternatively, means can be provided which serve as an abutment for the rocker device 30, 40. Adjustable abutment screws 60 serving this purpose are shown in FIG. 6.

An embodiment with four (or six or more) support means 52.1 to 52.4 can be so designed that in each instance two of the support means 52.1, 52.2 and 52.3, 52.4 are fastened in pairs to respective rocker devices 55.1 and 55.2. The rocker devices 55.1 and 55.2 are then in turn suspended together at a superordinate rocker device 55.3, as schematically shown in FIG. 7. The entire rocker device 55 is in turn supported on a guide rail 51.

Another embodiment of the present invention is distinguished by the fact that the support means are also fastened on the counterweight side to the guide rail there.

In accordance with the provisions of the patent statutes, the present invention has been described in what is considered to represent its preferred embodiment. However, it should be noted that the invention can be practiced otherwise than as specifically illustrated and described without departing from its spirit or scope.

1. An elevator installation including an elevator car comprising:
a guide rail extending along one side of the elevator car for vertical guidance of the elevator car;
at least two support means which extend parallel to one another and support a counterweight at a side of the elevator car and which underloop the elevator car, wherein each of said at least two support means has first and second ends fixed relative to vertical movement of the elevator car and fastened on opposite sides of the elevator car; and
a rocker device rotatably fastened to said guide rail for rocking movement, said rocker device and a support means fixing point provided at each of said arms, each of said support means fixing points being attached to one of said first and second ends of an associated one of said at least two support means one of said arms whereby when said arms are fastened to said guide rail and said support means are attached to said fixing points, said rocker device through said rocking movement prevents unequal loading of the support means.

2. The elevator installation according to claim 1 including another guide rail extending along another side of the elevator car for vertical guidance of the elevator car, said another guide rail supporting a drive laterally arranged above a path of travel of the elevator car.

3. The elevator installation according to claim 1 including another guide rail extending along another side of the elevator car for vertical guidance of the elevator car and wherein said at least two support means are substantially symmetrical with respect to a plane extending between said guide rails.

4. The elevator installation according to claim 1 wherein said at least two support means are flat belts or wedge-rib belts and support the elevator car in a 2:1 underlooping.

5. The elevator installation according to claim 1 including another guide rail extending along another side of the elevator car for vertical guidance of the elevator car, wherein an even-numbered total number of said at least two support means is used, wherein half the total number is arranged on one side and the other half of the total number is arranged on the other side of said guide rails.

6. The elevator installation according to claim 1 wherein said counterweight is laterally guided at the elevator car by two counterweight guide rails.

7. The elevator installation according to claim 1 including an abutment provided adjacent said rocker device to engage and mechanically limit said rocking movement.

8. The elevator installation according to claim 1 wherein said rocker device is supported on said guide rail such that vertically downwardly directed tension forces acting by way of said at least two support means are introduced into said guide rail in a region of a center of an area of a cross-section thereof.

9. The elevator installation according to claim 1 wherein said rocker device is connected with a limiting device for performing at least one of shutting down a drive of the elevator installation, actuating brakes of the elevator car and triggering a warning signal when the rocking movement goes beyond a limit value.

10. The elevator installation according to claim 9 wherein said limiting device is connected with a speed limiter of the elevator installation to brake the elevator car with a safety braking device.

11. A rocker device for use in an elevator installation, the elevator installation including an elevator car, at least one guide rail arranged on one side of the elevator car for vertical guidance of the elevator car, and at least two support means which extend parallel to one another and support a counterweight at a side of the elevator car and which underloop the elevator car, wherein each of the support means is fastened at opposite ends on opposite sides of the elevator car, the rocker device comprising:
two arms each having fastening means attaching one end of an associated one of the support means; and
an axis of rotation for rotatable attachment to the at least one guide rail, said fastening means being arranged symmetrically with respect to said axis of rotation.

12. The rocker device according to claim 11 including a limiting device which can be coupled with a speed limiter to at least one of shut down a drive of the elevator installation and brake the elevator car when said rocker device makes a rocking movement going beyond a limit value.

13. The rocker device according to claim 11 wherein said fastening means includes clamping or screw devices attaching the support means.
